(19) United States
(12) Patent Application Publication
(10) Pub. No.: US 2016/0221796 A1
(43) Pub. Date: Aug. 4, 2016

(54) ROPE TERMINAL ARRANGEMENT, ARRANGEMENT FOR CONDITION MONITORING OF AN ELEVATOR ROPE AND ELEVATOR

(71) Applicants: MIKKO PURANEN, Riihimaki (FI); Hannu Lehtinen, Numminen (FI); Pekka Hallikainen, Hyvinkaa (FI)

(72) Inventors: MIKKO PURANEN, Riihimaki (FI); Hannu Lehtinen, Numminen (FI); Pekka Hallikainen, Hyvinkaa (FI)

(73) Assignee: KONE Corporation, Helsinki (FI)

(21) Appl. No.: 15/010,664

(22) Filed: Jan. 29, 2016

(30) Foreign Application Priority Data
Feb. 3, 2015 (EP) 15153595.2

(51) Int. Cl. B66B 7/12; B66B 7/08

(52) U.S. Cl. CPC B66B 7/1223; B66B 7/085

(57) ABSTRACT

The invention concerns a rope terminal arrangement of an elevator comprising a rope terminal block mounted immovably on an end of a rope of an elevator, which rope comprises one or more load bearing members, which are electrically conductive and embedded in an electrically non-conductive coating and extend in longitudinal direction of the rope, and have an end face, which is free of said coating and forms part of the end face of the rope; and a contact arrangement for forming electrically conductive connection with one or more of the load bearing members of the rope, the contact arrangement being mounted on the rope terminal block and comprising at least one electrical connector, which electrical connector comprises a contact face, which is spring-loaded against an end face of a load bearing member of the rope whereby a conductive connection between the connector and the load bearing member is established via the contact face. The invention concerns further an arrangement for condition monitoring of an elevator rope and an elevator implementing said rope terminal arrangement.

This application claims priority to European Patent Application No. 15153595.2 filed on Feb. 3, 2015, the entire contents of which are incorporated herein by reference.

### FIELD OF THE INVENTION

The invention relates to a rope terminal arrangement of an elevator, to an arrangement for condition monitoring of a rope of an elevator as well as to an elevator. Said elevator is preferably an elevator for transporting passengers and/or goods.

### BACKGROUND OF THE INVENTION

Elevator ropes typically include one or several load bearing members that are elongated in the longitudinal direction of the rope and each form a structure that continues unbroken throughout the length of the rope. Load bearing members are the members of the rope which are able to bear together the load exerted on the rope in its longitudinal direction. The load, such as a weight suspended by the rope, causes tension on the load bearing member in the longitudinal direction of the rope, which tension can be transmitted by the load bearing member in question all the way from one end of the rope to the other end of the rope. Ropes may further comprise non-bearing components, such as an elastic coating, which cannot transmit tension in the above described way.

In prior art, such hoisting ropes exist where the load bearing members are embedded in a non-conducting coating, such as polymer coating forming the surface of the hoisting rope and extending between adjacent load bearing members thereby isolating them from each other both mechanically and electrically. For knowing condition of the ropes, and thereby for improving safety of the hoisting apparatus, monitoring of the condition of the load bearing members would be advantageous. In prior art condition monitoring has been proposed to be arranged by monitoring electrical parameters of the load bearing members. For this purpose, the load bearing members would need to be connected electrically conductively to a source of electricity. As a point of connection rope ends can be used as they are typically mounted immovably and thereby easily connectable with a terminal arrangement.

In prior art, such ropes exist where the load bearing members are formed of twisted wire strands of metal. The connection with this type of load bearing members is simple as they can each be peeled and connected to with a screw terminal as known for example from luminaires. Metal strands can be treated roughly without breaking them and the established connection is reliable and durable in various conditions. In addition, also such ropes exist, where said widely known solution for establishing an electrical connection is, for some reason, not feasible or even possible without complicated arrangements. This may be the case due to a special construction of the rope or the material of the load bearing members, for instance. Fragile materials, for example may fracture, which might result in discontinuities in the material.

Accordingly, it has come up a need for a solution, which can provide the electrically conductive connection with load bearing members which are not simply connected to by a screw terminal.

Furthermore, such solutions exist where said load bearing members are in the form of elongated composite members made of composite material comprising reinforcing fibers in polymer matrix. In this type of solutions, establishing the electrical connection has been particularly challenging owing to the fragility of the composite material of the load bearing members. In context of this type of ropes, a contact arrangement utilizing screws has been proposed in US2014182975A1.

### BRIEF DESCRIPTION OF THE INVENTION

The object of the invention is to provide an improved rope terminal arrangement of an elevator, an improved arrangement for condition monitoring of a rope of an elevator as well as an elevator. An object is to alleviate above mentioned problems of prior art and/or problems described or implied to later in the description. A solution is introduced where conductive connection with one or more load bearing members can be established reliably yet gently such that the rope need not be damaged. Advantageous embodiments are presented, which perform well when the rope has non-metallic load bearing members. Advantageous embodiments are presented, where the electrical connection can be maintained despite minor displacement of the load bearing member e.g. due to thermal expansion or shrinkage.

It is brought forward a new rope terminal arrangement of an elevator comprising a rope terminal block mounted immovably on an end of a rope of an elevator, which rope comprises one or more load bearing members, which are electrically conductive and embedded in an electrically non-conductive coating and extend in longitudinal direction of the rope, and have an end face, which is free of said coating and forms part of the end face of the rope; and a contact arrangement for forming electrically conductive connection with one or more of the load bearing members of the rope, the contact arrangement being mounted on the rope terminal block and comprising at least one electrical connector which electrical connector comprises a contact face, which is spring-loaded against an end face of a load bearing member of the rope whereby a conductive connection between the connector and the load bearing member is established via the contact face. Hereby, one or more of the above mentioned advantages and/or objectives are achieved. The spring-loading provides adaptability to slight relative displacement of the components. The connection is also simple, because the end face of the load bearing member provides a connection point, which is simply accessible. The rope terminal is preferably further implemented with one or more of the preferred features described in the following.

In a preferred embodiment, said contact arrangement is an interface for forming electrically conductive connection with one or more of the load bearing members of the rope, and comprises a connector whereto a connector of a source of electricity is/can be coupled.

In a preferred embodiment, said electrical connector comprises a spring mechanism for pressing the contact face of the electrical connector against the end face of the load bearing member of the rope. The aforementioned spring-loading is then provided by the spring mechanism.

In a preferred embodiment, the spring mechanism is located between the mounting point and the contact face of the electrical connector. Thus it is configured to take from the mounting point the reaction force needed for achieving the pressing against the end face of the load bearing member.

In a preferred embodiment, said at least one electrical connector comprises two of said electrical connectors conductively connected to each other and adjacent each other, their contact faces spring-loaded to press against the same end face of the same load bearing member. Thereby duplex connection with said load bearing member is formed.

In a preferred embodiment, the contact faces of said two electrical connectors are spring-loaded against spaced apart points of the same end face of a load bearing member. Thus, the effect of aberrations in surface structure or conductivity of the face of the load bearing member are eliminated, because it is likely that at least one of the spaced apart points is able to provide a foundation sufficiently conductive and topographically such that the contact face can rest against it with sufficiently vast contact area.

In a preferred embodiment, said two electrical connectors have each a distal end comprising the contact face of the connector in question, and the distal ends of the two electrical connectors are spaced apart from each other in transverse direction of the end of the rope.

In a preferred embodiment, said two electrical connectors are conductively connected to each other by connecting means comprised in the contact arrangement, such as connector line(s) of a circuit board of the contact arrangement. Thus, the electrical connectors can be discrete components. Alternatively, they can be connected by and isthmus joining them integrally together at a location apart from their distal ends. The spring mechanism is in each case preferably between the distal end and the connecting structure (i.e. the connector or the isthmus).

In a preferred embodiment, each said electrical connector is a discrete electrical component.

In a preferred embodiment, each said contact face of the electrical connector is continuously spring-loaded against the end face. Thereby the conductive connection between the connector and the load bearing member established via the contact face is continuous. This is implemented preferably such that the spring mechanism of each said electrical connector is arranged to press the contact face of the electrical connector continuously against the end face of the load bearing member of the rope.

In a preferred embodiment, said at least one electrical connector comprises plurality of said electrical connectors.

In a preferred embodiment, said electrical connector comprises a first contact member mounted immovably relative to the rope terminal block, and a second contact member mounted movably on the first contact member such that the first and the second contact member are in conductive connection, the second contact member are comprises said contact face, and the spring mechanism comprises a spring member arranged to urge the second contact member towards the end face of the load bearing member in question such that the contact face of the second contact member is pressed against the end face of the load bearing member. Preferably, the spring member is mounted between the first and second contact members. Preferably, the second contact member is mounted movably on the first contact member such that it can move linearly to and fro in longitudinal direction of the end of the rope. Preferably, the first and second contact member are telescopically connected to each other. Preferably, the first and second contact member are made of metal. Preferably, the first and second contact member are elongated. Preferably, the first and second contact member are telescopically connected to each other, one of the first and second contact member having an inside space accommodating a spring, preferably a helical spring, and an end of the other of the first and second contact member.

In a preferred embodiment, said electrical connector is a contact member mounted immovably relative to the rope terminal block, and comprises an elastically bendable arm and a distal end comprising said contact face, and the rope and the contact member are positioned relative to each other such that the arm is elastically bent to press the contact face against the end face of a load bearing member. Preferably, said contact member is a metal plate.

In a preferred embodiment, said load bearing members are made of electrically conductive material.

In a preferred embodiment, said load bearing members are made of electrically conductive composite material, composite material preferably comprising electrically conducting reinforcing fibers embedded in polymer matrix, said reinforcing fibers preferably being carbon fibers. The new solution for providing conductive connection is advantageous particularly in context of ropes where load bearing members are made of electrically conductive composite material. In this context, the connection is gentle as well as reliable, because the spring-loading provides adaptability to slight relative displacement of the components. Thereby, it provides a reduced likelihood of disconnection due to different thermal expansion properties of the connected components or fractures caused in the composite material. A composite material can be also easily made such that it has a substantially flat end face whereby it can be easily contacted with the electrical connector.

In a preferred embodiment, the rope terminal block comprises a slot for accommodating the rope end such that the end face of the rope faces the contact face of the connector. Preferably, the slot is configured for receiving the rope end by inserting the rope end into the slot in its axial direction.

In a preferred embodiment, the rope terminal block comprises one or plurality of parts.

In a preferred embodiment, the rope terminal arrangement comprises a blocking means for blocking displacement of the rope end in its axial direction such that it withdraws outwards from the contact face of the connector.

In a preferred embodiment, said blocking means are one-way blocking means allowing displacement of the end of the rope in its longitudinal direction forward towards the contact face of the connector and blocking displacement of the end of the rope in its longitudinal direction outwards from the contact face of the connector. Preferably, said one-way blocking means comprise wedge shaped protrusions comprised in the rope terminal block protruding into the slot's space for accommodating the end of the rope. Preferably, said wedge shaped protrusions have each an edge for blocking sliding of the end of the rope over it in one direction, particularly outwards from the contact face of the connector, as well as a ramp for facilitating sliding of the end of the rope over it over it in the other direction, particularly towards the contact face of the connector.

In a preferred embodiment, the end of the rope end has a polyvee shape with ribs and grooves extending in longitudinal direction of the end of the rope and the rope terminal block has a polyvee shape with ribs and grooves extending in longitudinal direction of the end of the rope forming a counterpart for the polyvee shape of the end of the rope, and the rope terminal arrangement comprises a blocking means for blocking displacement of the end of the rope in its longitudinal direction such that it withdraws outwards from the contact face of the connector which comprises an elongated member extending through the ribs of the end of the rope and the ribs of the rope terminal block.

In a preferred embodiment, said rope is belt-shaped, and thereby substantially larger in width direction than thickness direction.

In a preferred embodiment, the rope comprises plurality of adjacent load bearing members for bearing the load exerted on the rope in longitudinal direction thereof, the coating forming the surface of the rope and extending between adjacent load bearing members thereby isolating them in a non-conductive manner from each other.

In a preferred embodiment, said load bearing members are made of electrically conductive composite material. The composite material preferably comprises electrically conducting reinforcing fibers embedded in polymer matrix, said reinforcing fibers preferably being carbon fibers. Preferably over 50% proportion of the surface area of the transverse cross-section of the load bearing member consists of the aforementioned electrically conducting reinforcing fibers. Preferably, substantially all the remaining surface area of the cross-section is of polymer matrix. To be more precise preferably 50%-80% of the surface area of the cross-section of the load bearing member is of the aforementioned reinforcing fiber, most preferably such that 55%-70% is of the aforementioned reinforcing fiber, and substantially all the remaining surface area is of polymer matrix. Thereby, good load bearing function as well as conductivity can be ensured. The best results are achieved when approx. 60% of the surface area of the cross-section is of reinforcing fiber and approx. 40% is of matrix material. The reinforcing fibers are preferably long, in particular continuous fibers, whereby they will be in contact with each other randomly along their length whereby electricity brought into the load bearing member or received from it via the end face will be conducted within substantially the whole cross section of the load bearing member. Preferably, the reinforcing fibers of each said load bearing member are distributed in the polymer matrix of the load bearing member in question and bound together by it to form a one integral piece. The reinforcing fibers of each load bearing member are then preferably substantially evenly distributed in the polymer matrix of the load bearing member in question.

In a preferred embodiment, each said load bearing member is parallel with the length direction of the rope. Furthermore, referring to previous paragraph, it is preferable that said reinforcing fibers are parallel with the length direction of the rope. Thereby the fibers are also parallel with the longitudinal direction of the rope as each load bearing member is oriented parallel with the longitudinal direction of the rope. This facilitates further the longitudinal stiffness of the rope among other properties highly appreciated in a rope of an elevator.

It is also brought forward a new arrangement for condition monitoring of an elevator rope, the arrangement comprising a rope comprising one or more electrically conductive load bearing members, which are embedded in an electrically non-conductive coating and extend in longitudinal direction of the rope unbroken throughout its length, and have at least at one end of the rope an end face, which is free of said coating and forms part of the end face of the rope, and a rope terminal arrangement at said at least one end of the rope, said rope terminal arrangement comprising a rope terminal block mounted immovably on an end of the rope; and a contact arrangement for forming electrical connection with one or more of the load bearing members of the rope, the contact arrangement being mounted on the rope terminal block and comprising at least one electrical connector, which electrical connector comprises a contact face, which is spring-loaded against an end face of a load bearing member of the rope whereby a conductive connection between the connector and the load bearing member is established via the contact face; and a monitoring unit (CMU) electrically connected with one or more of the load bearing members of the rope via the contact arrangement of the rope terminal arrangement and configured to monitor condition of an electrical circuit at least partially formed by said load bearing members with which the monitoring unit (CMU) is electrically connected.

In a preferred embodiment, said load bearing members, with which monitoring unit is electrically connected, form each at least a part of an electrical circuit and the monitoring unit (CMU) is configured to monitor one or more electrical parameter of said circuit, and to determine condition of the circuit based on the electrical parameters. Preferably, said determining the condition of the circuit comprises determining whether one or more predefined limits set for the parameter(s) has/have been met. Preferably, the CMU is configured to carry out one or more predefined actions when it detects that one or more predefined limits set for the parameter(s) has/have been met. Preferably, said one or more predefined actions comprises indicating a fault situation and/or triggering a stop of the elevator car. Said indicating a fault situation can comprise sending a fault signal.

It is also brought forward a new elevator comprising a rope connected at least with the elevator car and provided with an arrangement for condition monitoring as defined in any of the preceding claims.

The elevator is preferably such that the car thereof is arranged to serve two or more landings. The elevator preferably controls movement of the car in response to calls from landing and/or destination commands from inside the car so as to serve persons on the landing(s) and/or inside the elevator car. Preferably, the car has an interior space suitable for receiving a passenger or passengers, and the car can be provided with a door for forming a closed interior space.

### BRIEF DESCRIPTION OF THE DRAWINGS

In the following, the present invention will be described in more detail by way of example and with reference to the attached drawings, in which

FIG. 1 illustrates a rope of an elevator.

FIG. 2 illustrates a rope terminal arrangement provided at an end of a rope of an elevator according to a first embodiment.

FIG. 3 illustrates cross section A-A of FIG. 2.

FIG. 4 illustrates an enlarged view of details of FIG. 3.

FIG. 5 illustrates cross section B-B of FIG. 3.

FIG. 6 illustrates rope terminal arrangement provided at an end of a rope of an elevator according to a second embodiment.

FIG. 7 illustrates cross section C-C of FIG. 6.

FIG. 8 illustrates an enlarged view of details of FIG. 7.

FIG. 9 illustrates cross section D-D of FIG. 7.

FIG. 10 illustrates an arrangement for condition monitoring of an elevator rope implementing the rope terminal arrangement of FIG. 2 or 6.

FIG. 11 illustrates an elevator implementing the arrangement for condition monitoring of an elevator of FIG. 10.

FIGS. 12 to 15 illustrate preferred additional details for the terminal block of the rope terminal arrangement illustrated in FIG. 2 or 6.

The foregoing aspects, features and advantages of the invention will be apparent from the drawings and the detailed description related thereto.

### DETAILED DESCRIPTION

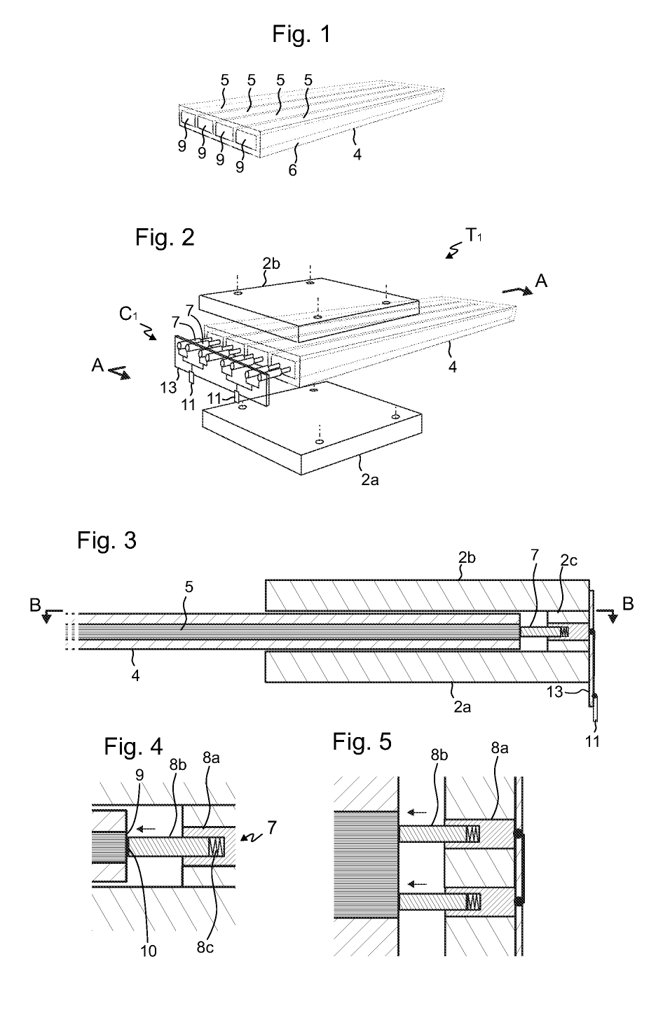

FIG. 1 illustrates a rope 4 of an elevator. The rope 4 illustrated is belt-shaped, and thereby larger in width direction than thickness direction. The rope 4 comprises load bearing members 5 for bearing the load exerted on the rope 4 in longitudinal direction thereof. The load bearing members 5 are electrically conductive and embedded in an electrically non-conductive coating 6 and extend in longitudinal direction of the rope 4 unbroken throughout its length. The coating 6 forms the surface of the rope 4. Each load bearing member has an end face 9, which is free of said coating 6 and forms part of the end face of the rope 4. In the illustrated rope 4, there is a plurality of said load bearing members 5 adjacent in width direction of the hoisting rope 4 extending parallel to each other as well as to the longitudinal direction of the hoisting rope 4. The coating 6 extends between adjacent load bearing members 5, thereby isolating them in a non-conductive manner from each other. The rope could alternatively have some other number of load bearing members 5, namely more or fewer than illustrated.

FIG. 2 illustrates an exploded view of an embodiment of a rope terminal arrangement T₁ of an elevator provided for a rope as presented in FIG. 1. FIGS. 3 to 5 illustrate details of the rope terminal arrangement T₁ in an assembled state. In its assembled state, the rope terminal arrangement T₁ comprises a rope terminal block 2 mounted immovably on an end of a rope 4 of an elevator. The rope terminal block 2 is here comprised of block members 2a 2b located on opposite sides of the rope end as well as of 2c located between members 2a,2b (showed in FIGS. 3 to 4 only). The rope terminal arrangement T₁ further comprises a contact arrangement C₁ for forming electrically conductive connection with one or more of the load bearing members 5 of the rope 4, which contact arrangement C₁ is mounted on the rope terminal block 2 and comprises electrical connectors 7, each of which electrical connectors 7 comprises a contact face 10, which is spring-loaded against an end face 9 of a load bearing member 5 of the rope 4. Thereby, a conductive connection between the connector 7 and the load bearing member 5 is established via the contact face 10. The arrangement can be used to provide a reliable conductive connection, because the spring-loading provides adaptability to slight relative displacement of the components. The connection is also simple to make, because the end face 9 provides a connection point, which simply accessible. The rope end need not substantially treated, such as peeled, for instance. In contrast to screw-type connections, the connection is also gentle for the rope, whereby it is compatible with many different materials, fragile materials included.

Each said spring-loaded electrical connector 7 comprises a spring mechanism for pressing the contact face 10 against the end face 9 of the load bearing member 5 of the rope 4. The spring mechanism is arranged to urge the contact face 10 in longitudinal direction of the end of the rope 4 as well as the load bearing member 5 against the end face 9.

In the preferred embodiment illustrated, the rope terminal arrangement T₁ is further such that said at least one electrical connector 7 comprises two of said electrical connectors 7 having a contact face 10 spring-loaded as defined, per one load bearing member. The two electrical connectors 7 are electrically conductively connected to each other and adjacent each other, their contact faces 10 spring-loaded to press against the same end face 9 of the same load bearing member 5. Thereby duplex connection with said load bearing member is formed. Hereby, the reliability of the contact is facilitated. This is here implemented further such that the contact faces 10 of said two electrical connectors 7 are spring-loaded to press against spaced apart points of the same end face 9 of a load bearing member 5. Thus, the effect of aberrations in surface structure or conductivity of the face of the load bearing member are eliminated, because it is likely that at least one of the spaced apart points is able to provide a foundation sufficiently conductive and topographically such that the contact face 10 can rest against it with sufficiently vast contact area. Said electrical connectors 7 have each a distal end comprising the contact face 10 of the connector in question, and the distal ends of the two electrical connectors 7 are spaced apart from each other in transverse direction of the rope 4. Said electrical connectors 7 are mounted immovably on a circuit board 13, which is mounted immovably on the block 2.

Said two electrical connectors 7 are conductively connected to each other by connecting means comprised in the contact arrangement C₁, in this case by connector line(s) of the circuit board 13 of the contact arrangement C₁. In this case, the electrical connectors are discrete components but alternatively, they can be connected by an isthmus joining the first parts 8a integrally together.

The electrical connectors 7 are more particularly such that each of them comprises a first contact member 8a mounted immovably relative to the rope terminal block 2, and a second contact member 8b mounted movably on the first contact member 8a such that the first and the second contact member 8a,8b are in conductive connection with each other, the second contact member comprising said contact face 10. As mentioned, each of the electrical connectors 7 comprises a spring mechanism. The spring mechanism comprises a spring member 8c arranged to urge the second contact member 8b towards the end face 9 of the load bearing member 5 such that the contact face 10 of the second contact member is pressed against the end face of the load bearing member 5. This is implemented in the illustrated embodiment such that the spring member 8c is mounted between the first and second contact members 8a,8b. The first and second contact member 8a,8b are electrically conductive, for which purpose they are preferably made of metal. As visible from FIG. 4, in this embodiment the second contact member 8b is mounted movably on the first contact member 8a such that it can move linearly to and fro in longitudinal direction of the rope 4. For this purpose, the first and second contact member 8a,8b are here telescopically connected to each other.

One of the first and second contact member 8a,8b has an inside space accommodating the spring member 8c, which is preferably a helical spring, at an end of the other of the first and second contact member.

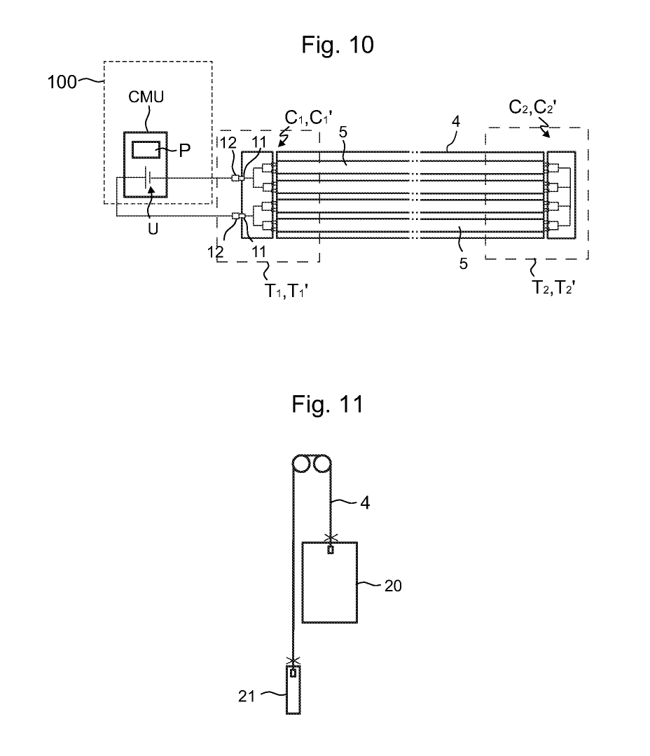

The contact arrangement C₁ described with reference to FIGS. 2 to 5 is an interface for forming electrically conductive connection with load bearing members 5 of the rope 4, and comprises two connectors 11 to which a connector 12 of a source U of electricity can be coupled, as illustrated in FIG. 10. Each connector 11 is electrically conductively connected, here by connector line(s) of the circuit board 13, with different electrical connectors 7. Thus, the via the interface connectors 12 of a source U of electricity can be coupled to connectors 11 that are in electrically conductive connection with different load bearing members 5 of the rope 4. The contact arrangement C₁ described with reference to FIGS. 2 to 5 can be modified easily to form a contact arrangement C₂ of a rope terminal arrangement T₂ as illustrated in FIG. 10 to be used in the opposite end of the rope 4. This can be carried out by omitting the connectors 11 and connecting all the connectors 7 to each other by connector line(s) of the circuit board 13, for instance. The contact arrangement C₂ as well as the rope terminal arrangement T₁₂as illustrated in FIG. 10 are preferably otherwise similar to C₂ and T₂ respectively.

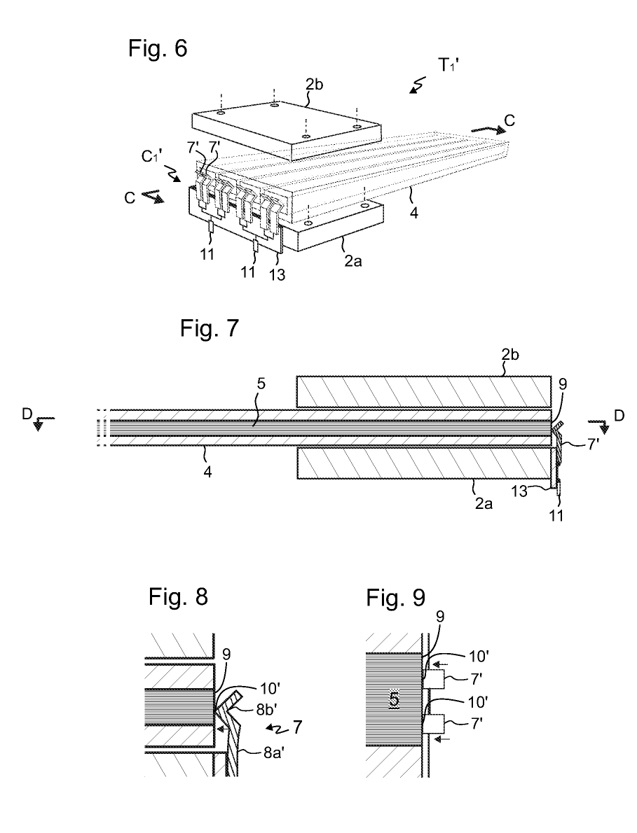

FIG. 6 illustrates an exploded view of an embodiment of a rope terminal arrangement T₁′ of an elevator provided for a rope 4 as presented in FIG. 1. FIGS. 7 to 9 illustrate details of the rope terminal arrangement T₁′ in an assembled state. In its assembled state, the rope terminal arrangement T₁′ comprises a rope terminal block 2 mounted immovably on an end of a rope 4 of an elevator. The rope terminal block 2 is here comprised of block members 2a,2b located on opposite sides of the rope end. The rope terminal arrangement T₁′ further comprises a contact arrangement C₁′ for forming electrically conductive connection with one or more of the load bearing members 5 of the rope 4, which contact arrangement C₁′ is mounted on the rope terminal block 2 and comprises electrical connectors 7′, each of which electrical connectors 7′ comprises a contact face 10′, which is spring-loaded against an end face 9 of a load bearing member 5 of the rope 4 whereby a conductive connection between the connector 7′ and the load bearing member 5 is established via the contact face 10′.

Each electrical connector 7′ having a contact face 10′ spring-loaded as defined comprises a spring mechanism for pressing the contact face 10′ against the end face 9 of the load bearing member 5 of the rope 4. The spring mechanism is arranged to urge the contact face 10′ in longitudinal direction of the rope 4 as well as the load bearing member 5 against the end face 9.

In the preferred embodiment illustrated, the rope terminal arrangement T₁′ is further such that said at least one electrical connector 7′ comprises two of said electrical connectors 7′ having a contact face 10′ spring-loaded as defined, per one load bearing member. The two electrical connectors 7′ are electrically conductively connected to each other and adjacent each other, their contact faces 10′ spring-loaded to press against the same end face 9 of the same load bearing member 5. Thereby duplex connection with said load bearing member is formed. Hereby, the reliability of the contact is facilitated. This is here implemented further such that the contact faces 10′ of said two electrical connectors 7′ are spring-loaded to press against spaced apart points of the same end face 9 of a load bearing member 5. Thus, the effect of aberrations in surface structure or conductivity of the face of the load bearing member are eliminated, because it is likely that at least one of the spaced apart points is able to provide a foundation sufficiently conductive and topographically such that the contact face 10′ can rest against it with sufficiently vast contact area. Said electrical connectors 7′ have each a distal end comprising the contact face 10′ of the connector in question, and the distal ends of the two electrical connectors 7′ are spaced apart from each other in transverse direction of the rope 4. Said electrical connectors 7′ are mounted immovably on a circuit board 13, which is mounted immovably on the block 2.

Said two electrical connectors 7′ are conductively connected to each other by connecting means comprised in the contact arrangement C₁′, in this case by connector line(s) of the circuit board 13 of the contact arrangement C₁′. In this case, the electrical connectors are discrete components but alternatively, they can be connected by an isthmus joining the electrical connectors 7′ integrally together at a location apart from their distal ends. In each case each of the two electrical connectors 7′ has its spring mechanism preferably between the distal end and the point of the electrical connector 7′ in question whereto the other is connected by the connector line or the isthmus.

As mentioned, each of the electrical connectors 7′ comprises a spring mechanism. The spring mechanism comprises is in this embodiment formed by an elastically bendable arm 8a′. The electrical connectors 7′ are more particularly such that each of them is a contact member mounted immovably relative to the rope terminal block 2, which contact member comprises an elastically bendable arm 8a′ and a distal end 8b′ comprising said contact face 10′, and the rope 4 and the contact member are positioned relative to each other such that the arm is elastically bent to press the contact face 10′ against the end face 9 of a load bearing member 5. Said contact member is electrically conductive, for which purpose it is preferably made of metal. Said contact member is preferably a bent metal plate.

The contact arrangement C₁′ described with reference to FIGS. 6 to 9 is an interface for forming electrically conductive connection with load bearing members 5 of the rope 4, and comprises two connectors 11 to which a connector 12 of a source U of electricity can be coupled, as illustrated in FIG. 10. Each connector 11 is electrically conductively connected, here by connector line(s) of the circuit board 13, with different electrical connectors 7′. Thus, the via the interface connectors 12 of a source U of electricity can be coupled to connectors 11 that are in electrically conductive connection with different load bearing members 5 of the rope 4. The contact arrangement C₁′ described with reference to FIGS. 6 to 9 can be modified easily to form a contact arrangement C₂′ of a rope terminal arrangement T₂′ as illustrated in FIG. 10 to be used in the opposite end of the rope 4. This can be carried out by omitting the connectors 11 and connecting all the connectors 7 to each other by connector line(s) of the circuit board 13, for instance. The contact arrangement C₂′ as well as the rope terminal arrangement T₂′ as illustrated in FIG. 10 are preferably otherwise similar to C₁′ and T₁′ respectively.

Said load bearing members 5 are made of electrically conductive material. They are preferably, but not necessarily made of electrically conductive composite material. The composite material preferably comprises electrically conducting reinforcing fibers embedded in polymer matrix. Said reinforcing fibers are preferably carbon fibers. Carbon fibers are preferable particularly for their excellent usability in elevator ropes due to their excellent load bearing ability and light weight. The number of the reinforcing fibers is to be great whereby they can together provide the load bearing member in question its ability bear load in the longitudinal direction of the load bearing member, the matrix on the other hand providing a function of binding the fibers together such that an integral element is formed by the matrix and the fibers. Preferably over 50% proportion of the surface area of the transverse cross-section of the load bearing member consists of the aforementioned electrically conducting reinforcing fibers. Preferably, substantially all the remaining surface area of the cross-section is of polymer matrix. To be more precise preferably 50%-80% of the surface area of the cross-section of the load bearing member is of the aforementioned reinforcing fiber, most preferably such that 55%-70% is of the aforementioned reinforcing fiber, and substantially all the remaining surface area is of polymer matrix. Thereby, good load bearing function as well as conductivity can be ensured. The best results are achieved when approx. 60% of the surface area of the cross-section is of reinforcing fiber and approx. 40% is of matrix material. The reinforcing fibers are preferably long, in particular continuous fibers, whereby they will be in contact with each other randomly along their length whereby electricity brought into the load bearing member or received from it via the end face will be conducted within substantially the whole cross section of the load bearing member. The load bearing members 5 are in the examples rectangular in cross-section, but this is not necessary as also other shapes for the cross sections can be utilized. The load bearing members are preferably more specifically as disclosed in international patent application WO2009090299A1. The coating 6 may be for example polyurethane coating or some other polymer-based coating.

In the examples, the spring loaded connectors are utilized in a limited number of examples. In the examples, each a contact arrangement C₁,C₁′,C₂,C₂′ of the respective rope terminal arrangement T₁,T₁′,T₂,T₂′ comprises several electrical connectors 7,7′. There are however different ways to implement the spring loaded connectors with alternative kinds of circuit layouts as well as with alternative number of electrical connectors 7,7′ than what is disclosed in the examples. The number of electrical connectors 7,7′ needed depends on how many load bearing members the rope has, and how many of them are being connected to. The number of electrical connectors 7,7′ needed depends further on whether a duplex connection is chosen to be utilized or not. The preferred construction of the rope terminal arrangement further depends on desired circuit layout, such as whether an interface for connecting to a source of electricity is wanted to be placed on one end only, as exemplified, or on both ends, in which case the positive and negative terminals (cf. connectors 12) of the source of electricity would be connected to contact arrangements of a rope terminal arrangement provided on opposite ends of the rope. The rope terminal arrangements can be modified to enable this kind of connection by providing one connector (cf. connector 11) on each contact arrangement of the rope terminal arrangements provided on opposite ends of the rope. This kind of configuration provides that only one load bearing member is electrically connected to, whereby the rope can be made to have as few as only one load bearing member if desired.

FIG. 10 illustrates an embodiment of an arrangement for condition monitoring of an elevator rope 4, which arrangement utilizes the rope terminal arrangement T₁,T₁′,T₂,T₂′ described above. The arrangement for condition monitoring comprises a rope 4 comprising one or more electrically conductive load bearing members 5, which are embedded in an electrically non-conductive coating 6 and extend in longitudinal direction of the rope 4 unbroken throughout its length, and have at the ends of the rope 4 end faces 9, each of which is free of said coating 6 and forms part of the end face of the rope 4. The arrangement for condition monitoring comprises a rope terminal arrangement T₁,T₁′,T₂,T₂′ at both ends of the rope 4. Each rope terminal arrangement T₁,T₁′,T₂,T₂′ comprises a rope terminal block 2 mounted immovably on an end of the rope 4; and a contact arrangement C₁,C₁′,C₂,C₂′ for forming electrical connection with one or more of the load bearing members 5 of the rope 4. Each contact arrangement C₁,C₁′,C₂,C₂′ is mounted on the rope terminal block 2 and comprising electrical connectors 7,7′, each electrical connector 7,7′ comprising a contact face 10,10′, which is spring-loaded to press against an end face 9 of a load bearing member 5 of the rope 4 whereby a conductive connection between the connector 7,7′ and the load bearing member 5 is established via the contact face 10,10′. The arrangement for condition monitoring further comprises a monitoring unit CMU electrically connected with load bearing members 5 of the rope 4 via the contact arrangements C₁,C₁′,C₂,C₂′ of the rope terminal arrangements and configured to monitor one or more electrical parameter of an electrical circuit at least partially formed by said load bearing members 5 with which the monitoring unit CMU is electrically connected. The arrangement is particularly such that said load bearing members, with which the monitoring unit CMU is electrically connected, form each a part of an electrical circuit and the monitoring unit CMU is configured to monitor condition of said circuit. Preferably, this is implemented such that CMU is configured to monitor one or more electrical parameter of the circuit, and to determine condition of the circuit based on the electrical parameters. Condition of the circuit can be used to indicate the condition of the load bearing members 5 of the rope 4. Said parameters can comprise for example resistance, voltage, current, or any combination of these, for example. Electrical parameters of the circuit are simply usable for determining condition of the circuit. For example increased resistance, drop in voltage or drop in current or inability to conduct an electrical signal can each mean that one or more of the load bearing members is fractured or cut. The CMU and the circuit can be designed to interact in various different ways. The CMU can be utilized for conducting an electrical output from a source of electricity U into the circuit. The source of electricity U can be used to conduct said electrical output continuously or intermittently. Practically any source of electricity U can be used.

Said determining the condition of the circuit can include determining whether one or more predefined limits set for the parameter(s) has/have been met. CMU can be further configured to carry out one or more predefined actions when it detects that one or more predefined limits set for the parameter(s) has/have been met. Such an action is preferably indicating a fault situation and/or triggering a stop of the elevator car. For the purpose of said monitoring function including the determination of the condition of the circuit, the CMU comprises one or more processor units P. The processor unit preferably comprises one or more microprocessors as well as one or more memory units connected with the microprocessor(s) storing a computer program and predetermined limits for the parameters, where needed. As mentioned said load bearing members 5 are made of electrically conductive material. For this end, they are preferably, but not necessarily made of electrically conductive composite material. With composite material, the spring-loaded contact is advantageous as they are difficult to contact by conventional means without damaging them. The composite material preferably comprises electrically conducting reinforcing fibers embedded in polymer matrix. Said reinforcing fibers are preferably carbon fibers. This kind of structure is used to make the load bearing members 5 electrically conducting and thereby suitable for serving as conductors of the arrangement.

In the examples the rope terminal arrangement T₁,T₁′,T₂,T₂′ utilizing the spring loaded connectors is provided at both ends of the rope. However, it is not necessary that this is the case as it is possible to provide the rope terminal arrangement T₁,T₁′,T₂,T₂′ at one end of the rope and some other type of arrangement at the opposite end of the rope, such as one known from prior art.

FIG. 11 illustrates an elevator comprising a rope 4 connected with a vertically movable elevator car 20. The elevator is provided with an arrangement for condition monitoring of an elevator rope 4 as described above. The elevator further comprises a vertically movable counterweight 21. The rope 4 is in this case a suspension rope. The rope 4 is fixed to the car 20 by a rope clamp c. A rope terminal arrangement T₁,T₁′ as earlier described is provided at the end of the rope 4 close to the rope clamp c at the untensioned side of thereof. The rope 4 is fixed correspondingly to the counterweight 21 by rope clamp c. A rope terminal arrangement T₂,T₂′ as earlier described is provided at the end of the rope 4 close to the rope clamp c at the untensioned side of thereof.

In FIGS. 2 to 9, the terminal block 2 includes bolt holes which can be used for mounting the parts of the block immovably to each other so as to produce a solid block comprised of several parts. The tightening of the bolts may further be used for clamping the rope between the block parts 2a and 2b. The mounting of the components relative to each other with this kind of means is however not necessary as the mounting can be alternatively or in addition to said bolt-type fixing provided by numerous other ways.

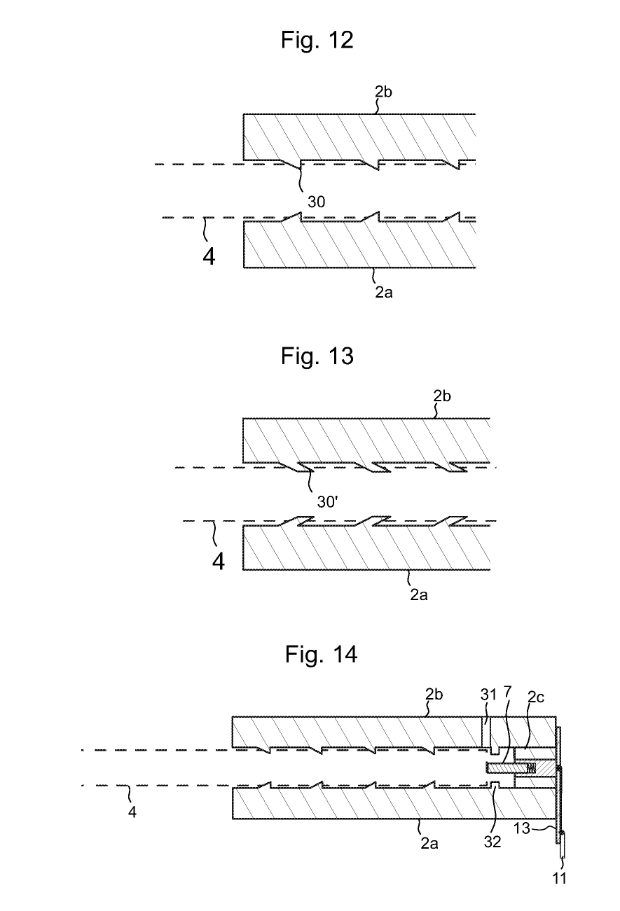

FIGS. 12 to 15 illustrate alternative preferred additional details for the terminal block 2 of the rope terminal arrangement T₁,T₁′ illustrated in FIG. 2 or 6 and for how the terminal block 2 is mounted immovably on an end of a rope 4. In each case the rope terminal block 2 comprises a slot for accommodating the rope end such that the end face 9 of the rope 4 faces the contact face 10,10′ of the connector 7,7′ as already disclosed in FIGS. 2 and 6. The rope terminal arrangement T₁,T₁′ further comprises blocking means 30,30′,30″ for blocking displacement of the rope end in its axial direction such that it withdraws outwards (towards left in FIGS. 12-15) from the contact face 10,10′ of the connector 7,7′.

FIGS. 12 to 14 illustrate blocking means of the first type. That is, said blocking means are one-way blocking means allowing displacement of the rope end in its axial direction forward towards the contact face 10,10′ of the connector 7,7′ and blocking displacement of the rope end in its axial direction outwards from the contact face 10,10′ of the connector 7,7′. Said one-way blocking means 30,30′ comprise wedge shaped protrusions 30,30′ comprised in the rope terminal block 2, which protrude into the space of the slot provided for accommodating the rope end. Said wedge shaped protrusions 30,30′ have each an edge for blocking sliding of the rope end over it in one direction outwards from the contact face 10,10′ of the connector 7,7′ and a ramp for facilitating sliding of the rope over it in the other direction towards the contact face 10,10′ of the connector 7,7′. The slot for accommodating the rope end is preferably configured for receiving the rope end by inserting the rope end into the slot in its axial direction.

The rope terminal block 2 further comprises an opening 31 allowing unobstructed view into the space of the slot at the contact point of the end face 9 and the contact face 10,10′. Thus, it can be visually verified whether a contact is realized between the faces 9 and 10,10′. Thus, it can be verified the rope 4 is positioned accurately in a correct position. The rope terminal block 2 further comprises a stop block 32 for limiting range of movement of the rope in the slot towards the contact member 7,7′. Thus, the rope 4 positioning accurately in a correct position is facilitated.

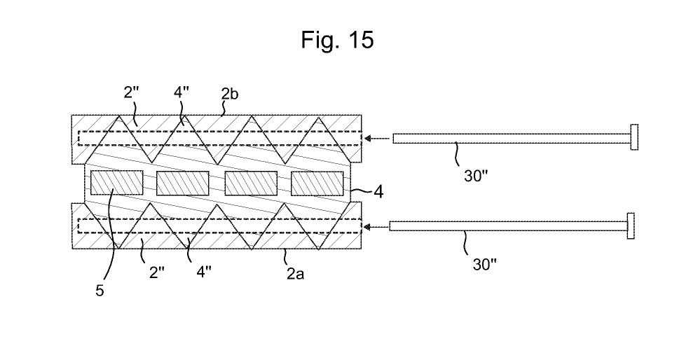

FIG. 15 illustrates blocking means 30″ of the second type. This type is advantageous when the rope 4 is belt-shaped and has a polyvee shape on one or both of its wide sides. In FIG. 15, the rope end has a polyvee shape with ribs and grooves extending in longitudinal direction of the rope end and the rope terminal block 2 has correspondingly a polyvee shape with ribs and grooves extending in longitudinal direction of the rope end forming a counterpart for the polyvee shape of the rope end. The blocking means 30″ block displacement of the rope end in its axial direction such that it withdraws outwards (towards left in FIG. 5) from the contact face 10,10′ of the connector 7,7′. For this end, the blocking means 30″ comprise an elongated member 30″ extending through the ribs 4″ of the rope end and the ribs 2″ of the rope terminal block. These ribs 2″ and 4″ are provided with a hole extending through them, thus providing that the elongated member 30″ can be inserted to extend through them easily. The elongated member 30″ is preferably in the form of a pin, nail or screw.

In the examples illustrated, the rope terminal block 2 comprises several parts. However, it could alternatively be made as a one-piece structure.

In this application, when referring to conductivity, it is meant electrical conductivity.

Generally, as a result of the contact face 10 being spring-loaded against the end face 9 these two are in direct contact with each other. This provides a conductive connection between them. Owing to the spring-loading, the contact can be maintained even in if the rope is slightly displaced relative to the rope terminal block. The connection is meant to be permanent, for which purpose the spring-loading is continuous. That is, the contact face of the electrical connector 7,7′ is continuously spring-loaded against the end face, whereby the conductive connection between the connector 7,7′ and the load bearing member 5 established via the contact face 10 is continuous. This is implementable, as it is the case with the illustrated preferred embodiments, such that the spring mechanism is arranged to press the contact face 10,10′ of the electrical connector 7,7′ continuously against the end face 9 of the load bearing member 5 of the rope 4.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims and their equivalents.

1. A rope terminal arrangement of an elevator comprising
a rope terminal block mounted immovably on an end of a rope of an elevator, which rope comprises one or more load bearing members, which are electrically conductive and embedded in an electrically non-conductive coating and extend in longitudinal direction of the rope, and have an end face, which is free of said coating and forms part of the end face of the rope; and
a contact arrangement for forming electrically conductive connection with one or more of the load bearing members of the rope, the contact arrangement being mounted on the rope terminal block and comprising at least one electrical connector, which electrical connector comprises a contact face, which is spring-loaded against an end face of a load bearing member of the rope whereby a conductive connection between the connector and the load bearing member is established via the contact face.

2. A rope terminal arrangement according to claim 1, wherein said contact arrangement is an interface for forming electrically conductive connection with one or more of the load bearing members of the rope, and comprises at least one connector whereto a connector of source electricity is or can be coupled.

3. A rope terminal arrangement according to claim 1, wherein each said electrical connector comprises a spring mechanism for pressing the contact face of the electrical connector against the end face of the load bearing member of the rope.

4. A rope terminal arrangement according to claim 1, wherein said at least one electrical connector comprises two of said electrical connectors conductively connected to each other and adjacent each other, their contact faces spring-loaded against the same end face of the same load bearing member.

5. A rope terminal arrangement according to claim 4, wherein the contact faces of said two electrical connectors are spring-loaded against spaced apart points of the same end face of the same load bearing member.

6. A rope terminal arrangement according to claim 4, wherein said two electrical connectors have each a distal end comprising the contact face of the connector in question, and the distal ends of the two electrical connectors are spaced apart from each other in transverse direction of the end of the rope.

7. A rope terminal arrangement according to claim 4, wherein said two electrical connectors are conductively connected to each other by connecting means comprised in the contact arrangement , such as connector line(s) of a circuit board of the contact arrangement.

8. A rope terminal arrangement according to claim 1, wherein each said electrical connector comprises a first contact member mounted immovably relative to the rope terminal block, and a second contact member mounted movably on the first contact member such that the first and the second contact member are in conductive connection, the second contact member comprising said contact face, and the spring mechanism comprises a spring member arranged to urge the second contact member towards the end face of the load bearing member in question such that the contact face of the second contact member is pressed against the end face of the load bearing member.

9. A rope terminal arrangement according to claim 8, wherein the second contact member is mounted movably on the first contact member such that it can move linearly to and fro in longitudinal direction of the end of the rope.

10. A rope terminal arrangement according to claim 8, wherein the first and second contact member are telescopically connected to each other.

11. A rope terminal arrangement according to claim 1, wherein said electrical connector is a contact member mounted immovably relative to the rope terminal block, and comprises an elastically bendable arm and a distal end comprising said contact face, and the rope and the contact member are positioned relative to each other such that the arm is elastically bent to press the contact face against the end face of a load bearing member.

12. A rope terminal arrangement according to claim 1, wherein said load bearing members are made of electrically conductive material, preferably of electrically conductive composite material, the composite material preferably comprising electrically conducting reinforcing fibers embedded in polymer matrix, said reinforcing fibers preferably being carbon fibers.

13. A rope terminal arrangement according to claim 1, wherein the rope terminal arrangement comprises a blocking means for blocking displacement of the rope end in its axial direction such that it withdraws outwards from the contact face of the connector, said blocking means being one-way blocking means allowing displacement of the end of the rope in its longitudinal direction forward towards the contact face of the connector and blocking displacement of the rope end in its longitudinal direction outwards from the contact face of the connector.

14. A rope terminal arrangement according to claim 1, wherein the end of the rope has a polyvee shape with ribs and grooves extending in longitudinal direction of the end of the rope and the rope terminal block has a polyvee shape with ribs and grooves extending in longitudinal direction of the end of the rope forming a counterpart for the polyvee shape for the end of the rope, and the rope terminal arrangement comprises a blocking means for blocking displacement of the end of the rope in its axial direction such that it withdraws outwards from the contact face of the connector, which blocking means comprises an elongated member extending through the ribs of the end of the rope and the ribs of the rope terminal block.

15. An arrangement for condition monitoring of an elevator rope, the arrangement comprising
a rope comprising one or more electrically conductive load bearing members, which are embedded in an electrically non-conductive coating and extend in longitudinal direction of the rope, and have at least at one end of the rope an end face, which is free of said coating and forms part of the end face of the rope, and
a rope terminal arrangement at said at least one end of the rope, said rope terminal arrangement comprising a rope terminal block mounted immovably on an end of the rope; and a contact arrangement for forming electrical connection with one or more of the load bearing members of the rope, the contact arrangement being mounted on the rope terminal block and comprising at least one electrical connector, which electrical connector comprises a contact face, which is spring-loaded against an end face of a load bearing member of the rope whereby a conductive connection between the connector and the load bearing member is established via the contact face; and
a monitoring unit electrically connected with one or more of the load bearing members of the rope via the contact arrangement of the rope terminal arrangement and configured to monitor condition of an electrical circuit at least partially formed by said one or more load bearing members with which the monitoring unit is electrically connected.

16. An elevator comprising an elevator car and a rope connected with the elevator car and provided with an arrangement for condition monitoring as defined in claim 15.
